(19) United States
(12) Patent Application Publication
(10) Pub. No.: US 2007/0018468 A1
(43) Pub. Date: Jan. 25, 2007

(54) Tubular handheld device

(76) Inventor: Thomas Behringer, Bietigheim (DE)

Correspondence Address: PATENTANWAELTE LICHTI + PARTNER GBR, POSTFACH 41 07 60, D-76207, KARLSRUHE, DE

(21) Appl. No.: 10/582,875

(22) PCT Filed: Jan. 20, 2005
(86) PCT No.: PCT/EP05/00510

§ 371 Date: Jun. 14, 2006

(30) Foreign Application Priority Data
Jan. 22, 2004 (DE) 10 2004 003 188.6

(51) Int. Cl. B25J 13/00

(52) U.S. Cl. 294/87.1

(57) ABSTRACT

A tube handling device for inserting tubes into a tube filling machine, relocating tubes within the tube filling machine and/or removing tubes from the tube filing machine, comprises at least one movable carrier having a plurality of tube grippers disposed in at least one gripper row. An adjusting device is disposed on the carrier comprising at least one drive device whose drive mechanism can be translated into a relative motion of the tube grippers along the gripper row using a transfer device. The tube grippers can be adjusted using the adjusting device between a first relative position in which they have a first predetermined mutual distance, and at least one second relative position in which they have a second predetermined mutual distance. The transfer device is thereby formed by scissor action arms which can be pulled apart and pushed together using the drive device. The drive device is formed by two pneumatic cylinders oriented parallel in the longitudinal direction of the gripper row and acting in opposite directions.

The invention concerns a tube handling device for inserting tubes into a tube filling machine, for relocating tubes within a tube filling machine and/or for removing tubes from the tube filling machine, in accordance with the pre-characterizing part of claim 1.

In a tube filling machine, the tubes must be grasped and relocated between different stations or machine sections. The empty, open tubes are usually stored in a densely packed form proximate to the tube filling machine, e.g. in corresponding containers, and must be inserted into the tube holders in which they pass through the different stations of the tube filling machine. When the tubes have been filled and sealed, they must be removed from the tube holders and either be supplied to a downstream packaging machine or be inserted, in a densely packed form, directly into a support or carton.

Insertion of the empty and open tubes into the tube holder is explained below by way of example. The invention also concerns other handling and relocating processes of the tubes in the tube filling machine.

WO 00/64749 A1 discloses a tube handling device having an industrial robot whose arm comprises a carrier with a plurality of tube grippers. The tube grippers are disposed in at least one gripper row which usually comprises 10 to 15 tube grippers. In order to receive tubes from the supply and insert them into the tuber holders of the tube filling machine, the robot arm is displaced in such a manner that the carrier, including tube grippers, is disposed above the vertically oriented tubes, which are open at the top. Each tube gripper then enters one empty tube from above and grasps it. This may be effected only by friction or also by correspondingly adjustable gripper elements.

The tubes are removed from the supply by displacing the robot arm, and moved to a position on the respective tube holder of the tube filing machine. The robot arm inserts the tubes into the tube holders and subsequently releases them, such that the tubes in the tube holders can pass through several stations of the tube filling machine, e.g. a filling station and a sealing station.

The tubes in the supply are usually tightly packaged. The tube holders, however, are spaced apart from each other, with the result that the mutual separation between the tube grippers must be changed during the relocating process. In order to permit gripping of the empty tubes from the supply, the tube grippers must have a first, relatively small mutual separation, whereas, for inserting the tubes into the tube holders, the tube grippers must have a second mutual separation which is larger than the first mutual separation, i.e. the tube grippers and therefore also the tubes must be pulled apart in the longitudinal direction of the gripper row.

The separation between the tube grippers is conventionally changed by interconnecting the tube grippers via a flexible belt and engagement of a drive device in the form of a pneumatic cylinder on the first and last tube gripper of the gripper row. The pneumatic cylinders move the first and the last tube grippers in opposite directions and this motion is transmitted via the belt to the inner tube grippers of the gripper row, which are successively displaced. In the final position, the belt is tightened and the tube grippers are in pulled apart positions at mutual separations from each other which corresponds to the separation between the tube holders.

In order to move the tube grippers from their pulled-apart position back into the pushed-together position, the first and the last tube grippers of the gripper row are moved towards each other by the pneumatic cylinders. Since the belt connecting the tube grippers cannot transfer any pressure, the two outer tube grippers initially contact the neighboring tube grippers and move them towards each other until they contact their neighboring, inner tube grippers, thereby also displacing them. This motion is continued until all tube grippers of the gripper row have been completely pushed together and assume a compressed configuration which is optionally defined by spacers, and in which they have a mutual separation which corresponds to the mutual separation between the tubes in the supply.

The conventional construction is disadvantageous, in particular, because the tube holders have a uniform mutual separation only in the pulled-apart position and in the pushed-together position, while the separation between the tube grippers in all intermediate positions differs. In this manner, the tube grippers are adjusted to a certain tube shape, a special arrangement of the tubes in the supply as well as to the mutual separation of the tube holders of the tube filling machine. In order to adjust the tube grippers e.g. to another tube size or another arrangement of the tubes in the supply, the tube grippers and the belt must be removed and adjusted to the changed geometry using a different belt. This method is cumbersome, time-consuming and expensive.

Moreover, it has turned out that the belt is subjected to a relatively great amount of wear and must be replaced at regular time intervals, during which the tube filling machine is inoperative, which is uneconomical. Furthermore, the belt may be locally deformed or stretched after long operating times, preventing the tube grippers from assuming their desired relative positions with the required high degree of accuracy.

CH 399 987 discloses a tube filling machine which also permits change of the mutual separation between the tubes. The tube filling machine, however, has no tube gripper but several tubular tube holders which are disposed in one row and into each of which one tube is inserted with play, wherein the tube is prevented from falling out of the tube holder by a plate disposed on the bottom side. The mutual separation between the tube holders is adjusted by scissor action arms which are pulled apart and pushed together by a piston via a fork. This design is disadvantageous in that the piston acting as drive device must perform a large lifting motion to completely pull apart or push together the scissor action arms. Adjustment of the scissor action arms in this manner takes a relatively long time, thereby reducing the performance of the tube filling machine. The positioning accuracy may additionally decrease, in particular, after long operation, since the piston exerts an eccentric drive force onto the scissor action arms, which produces irregular loads and internal tension.

It is the underlying purpose of the invention to provide a tube handling device of the above-mentioned type which permits rapid and precise adjustment of the tube grippers and also ensures high positioning accuracy even over long operating periods.

This object is achieved in accordance with the invention with a tube handling device having the characterizing features of claim 1. The transfer device is thereby formed by scissor action arms which can be pulled apart and pushed together using the drive device, the drive device being formed by two pneumatic cylinders which are oriented parallel to each other in the longitudinal direction of the gripper row and which act in opposite directions.

Scissor action arms are a conventional structural element formed by a plurality of hinged, in particular bar-shaped, rod parts. Two bar-shaped parts each are disposed to form a cross, i.e. disposed in an X-shaped configuration, and hinged at their crossing points to form a so-called X component. Several X components are disposed next to each other in a row to form the scissor action arms, wherein each free end of the bar-shaped parts is hinged to an associated free end of the neighboring X component.

When an axial pressure or normal force is exerted on such scissor action arms, the scissor action arms are shortened in that all X components equally pivot about the joint at their crossing points. The geometry of the X components of the scissor action arms is identically changed irrespective of the location where the pressure is introduced into the scissor action arms. The same applies, of course, when a tensile force is introduced into the scissor action arms.

The tube grippers of the inventive tube handling device are disposed on the X components of the scissor action arms. The scissor action arms thereby extend substantially in the longitudinal direction of the carrier and the tube grippers are each disposed in a lower hinge point of the scissor action arms, i.e. a point where neighboring X components are hinged to each other.

When the scissor action arms are pulled apart, the mutual separations between the lower hinge points of the X components of the scissor action arms as well as between the tube grippers change, wherein, however, the distance between neighboring tube grippers always remains the same in each state of the adjustment motion. Adjustment of the tube handling device to a different tube size or a different tube arrangement in the supply therefore requires no changes. Only the desired position must be defined and, in particular, stored in the control means of the tube handling device.

Two pneumatic cylinders are used as the drive device of the scissor action arms and engage at different points of the scissor action arms. The two pneumatic cylinders are disposed parallel to each other in the longitudinal direction of the gripper row and act in opposite directions. In their retracted state, the pneumatic cylinders are disposed substantially next to each other. This yields a very compact structure of the tube handling device, which therefore requires very little space.

In order to completely pull apart or push together the scissor action arms, each pneumatic cylinder must move by only half the adjustment path. This halves the adjustment time. For this reason, the tube filling machine has high efficiency at high cycle rates.

The drive device is formed by two pneumatic cylinders, which realises the scissor action arms structure with a substantially symmetrical mass distribution or a substantially central center of mass. This results in uniform adjustment motions, reducing the load on the scissor action arms. Since the scissor action arms are therefore not subjected to wear, or only to a small degree, the inventive tube handling device ensures highly accurate positioning of the tube gripper even during long operating times. The pneumatic cylinders are thereby preferably motionally synchronized to avoid secondary bending loads in the scissor action arms.

In order to obtain a uniform adjustment motion of the scissor action arms, it has moreover turned out to be advantageous for each pneumatic cylinder to engage approximately at 1/4 point of the length of the scissor action arms. When the scissor action arms are formed e.g. from 14 X components, the pneumatic cylinders should engage in the region of the third or fourth X component and also in the region of the eleventh or twelfth X component.

The inventive tube handling device preferably also comprises a robot with an adjustable pivot arm to which the carrier is mounted, (also shown in WO 00/64749 A1).

Further details and features of the invention can be extracted from the following description of an embodiment with reference to the drawing.

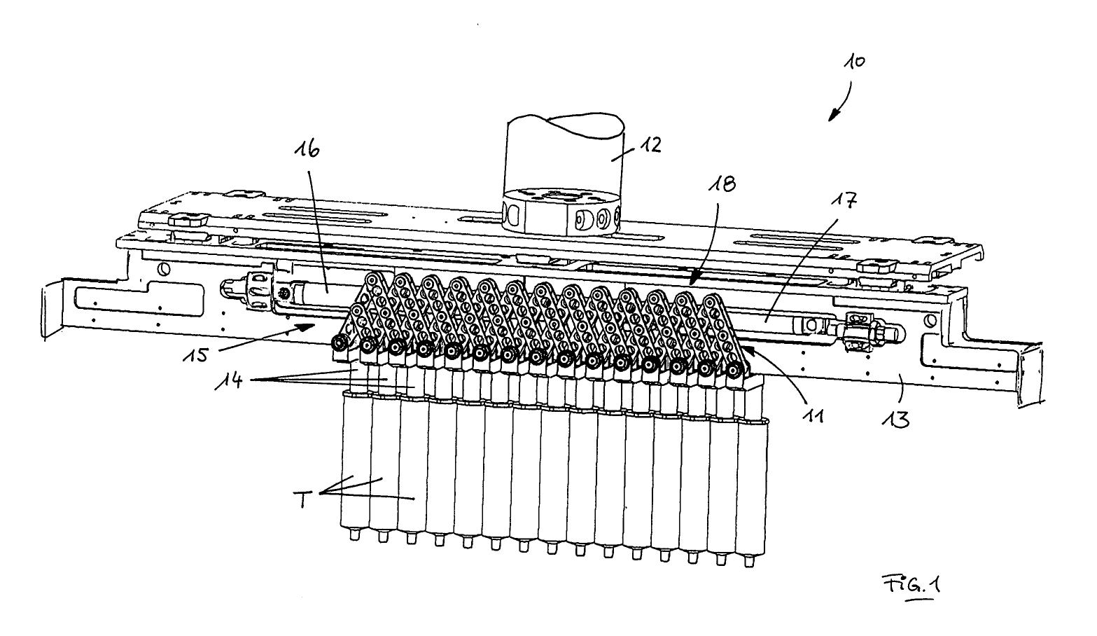

FIG. 1 shows a front view of the carrier of the tube handling device including tube grippers and received tubes;

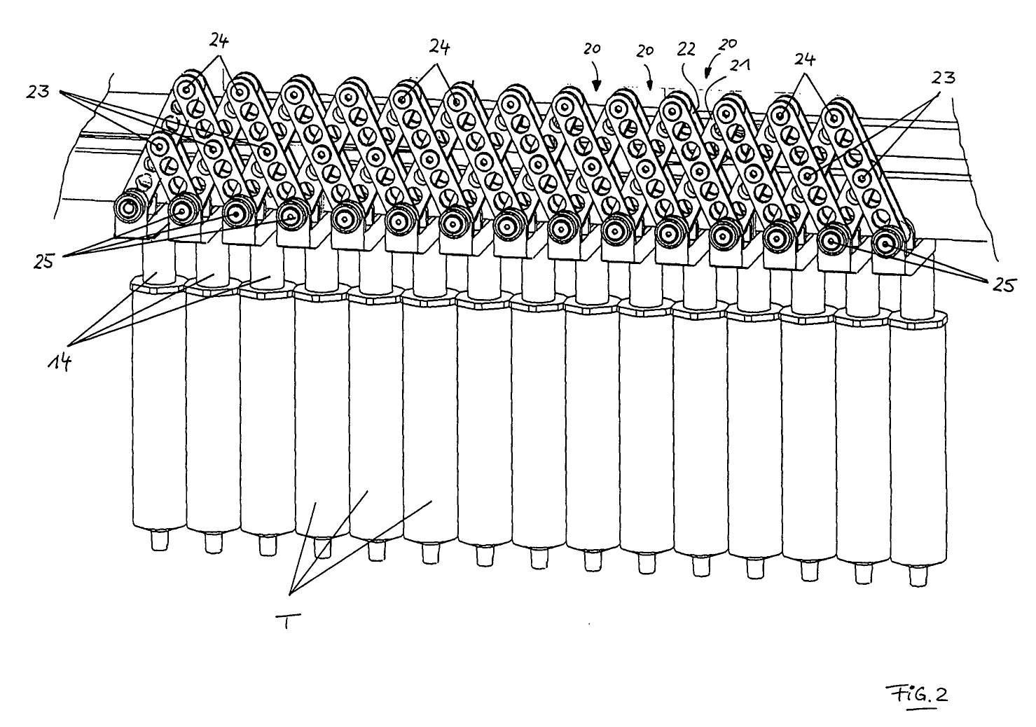

FIG. 2 shows an enlarged view of the transfer device of FIG. 1;

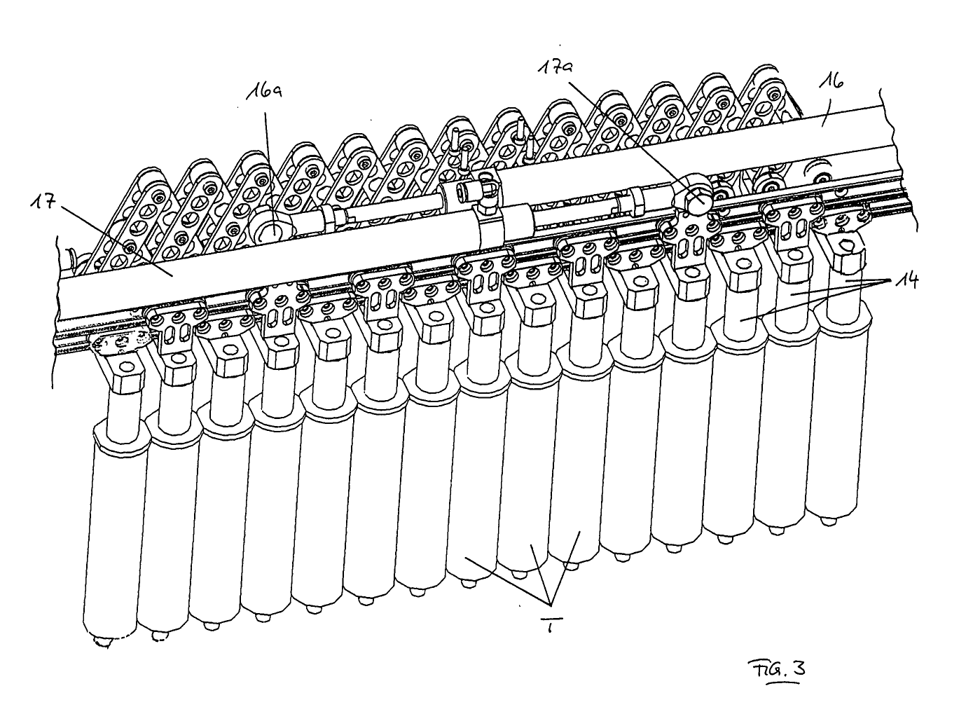

FIG. 3 shows a perspective rear view in sections of the device of FIG. 1; and

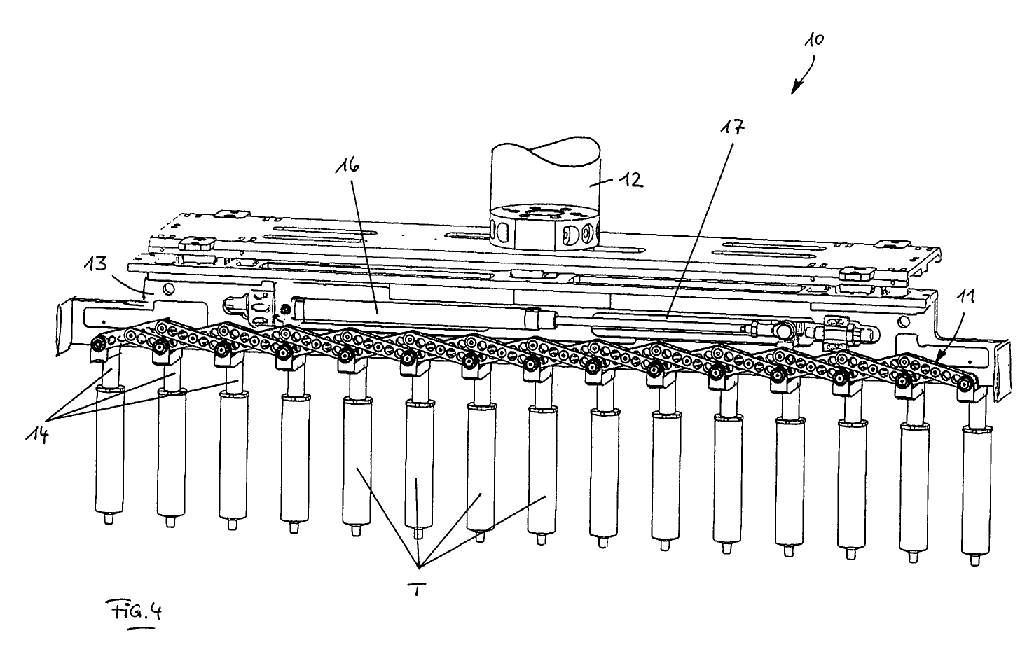

FIG. 4 shows the device of FIG. 1 with the tube grippers being pulled apart.

A tube handling device 10 comprises an industrial robot (not shown in detail) having a robot arm 12 which can be conventionally adjusted in space about a plurality of axes and at the free end of which a transverse strut 13 is disposed. A plurality of tube grippers 14 are disposed on the carrier 13 via an adjusting device 15, the tube grippers being disposed next to each other in a gripper row extending in the longitudinal direction of the carrier 13. The adjusting device 15 comprises two pneumatic cylinders 16, 17, which are oriented parallel to each other and in the longitudinal direction of the carrier 13 and act in opposite directions, and a transfer device 18 in the form of scissor action arms 11 for translating a motion of the pneumatic cylinders 16, 17, into a relative motion of the tube grippers 14 along the gripper row.

FIG. 2 shows, in particular, that the scissor action arms 11 are formed from a plurality of hinged substantially bar-shaped rod parts. Two rod parts 21, 22 each are disposed to form an X and are hinged to each other at their central crossing point 23, forming a so-called X component 20. The scissor action arms 11 are formed by several X components 20 disposed in a row next to each other, wherein the free ends of the respective bar-shaped rod parts facing each other are each hinged to the free ends of the respectively neighboring X component 20 facing each other, thereby forming upper hinge points 24 and lower hinge points 25. One tube gripper 14 projecting vertically downward is disposed on each of the lower hinge points 25, and can be inserted into an open tube T to receive or grip it.

FIG. 3 shows, in particular, that one end of each pneumatic cylinder 16, 17 is mounted to a carrier 13, and the free end of each extractable piston 16a, 17a is mounted to the scissor action arms 11 at approximately 1/4 of the length of the scissor action arms 11. When the pneumatic cylinders 16, 17 are extracted, a tensile force acts on the scissor action arms 11, pivoting the bar-shaped rod parts 21, 22 of each X component 20 about their crossing point 23 relative to each other and lengthening the overall scissor action arms 11, thereby increasing the mutual distance between neighboring lower hinge points 25 and therefore also the mutual distance of neighboring tube grippers 14.

When the pneumatic cylinders 16, 17 are retracted, the scissor action arms 11 are correspondingly pushed together, thereby reducing the mutual distance between the lower hinge points 25 of the X components 20 and thereby also the mutual distance between the tube grippers 14. In this manner, the mutual distance between the tube grippers 14 can be adjusted through corresponding control of the pneumatic cylinders 16, 17 and/or through defining corresponding final positions between different positions.

FIGS. 1 through 3 show the pushed-together state of the scissor action arms 11, wherein the tube grippers 14 are sufficiently close to each other that they can receive directly abutting tubes T. The tubes T are removed from a supply in this position. During the motion for transferring the tubes T to be inserted into the tube holders of the tube filling machine, the pneumatic cylinders 16 and 17 are activated, thereby pulling the scissor action arms 11 apart and increasing the mutual distance between the tube grippers 14 (FIG. 4). In this state, with the extracted piston of each pneumatic cylinder being disposed next to the cylinder of the respectively other pneumatic cylinder, the tubes T can be inserted into the tube holders of the tube filling machine. While the tube handling device returns to the tube supply, the scissor action arms 11 are pushed together again and the tube grippers 14 return to the relative position shown in FIGS. 1 through 3.

1-4. (canceled)

5. A tube handling device for inserting tubes into a tube filling machine, for relocating tubes within the tube filling machine, and/or for removing tubes from the tube filling machine, the device comprising:
at least one movable carrier;
an adjusting device disposed on said movable carrier, said adjusting device having at least one drive device comprising two pneumatic cylinders, disposed parallel to each other, said pneumatic cylinders structured to act in opposite directions;
a transfer device having scissor action arms cooperating with said pneumatic cylinders; and
a plurality of tube grippers for grasping the tubes, said grippers disposed on said scissor arms in at least one gripper row, wherein, in response to pushing and pulling of said scissor action arms by motion of said pneumatic cylinders in a longitudinal direction of said gripper row, a drive motion of said drive device is translated by said transfer device into a relative motion of said tube grippers along said gripper row to adjust said tube grippers between a first relative position at which said grippers assume a first defined mutual separation and at least one second relative position in which said grippers assume a second defined mutual separation.

6. The tube handling device of claim 4, wherein said scissor action arms substantially extend in a longitudinal direction of said carrier and said tube grippers are each disposed in a lower hinge point of said scissor action arms.

7. The tube handling device of claim 4, wherein said pneumatic cylinders engage said scissor action arms at approximately 1/4 of a length thereof.

8. The tube handling device of claim 4, wherein a motion of said pneumatic cylinders is synchronized.
